(19) United States
(12) Patent Application Publication
(10) Pub. No.: US 2005/0274669 A1
(43) Pub. Date: Dec. 15, 2005

(54) Wastewater treatment system

(75) Inventors: Guy Marchesseault, Boxford, MA (US); Thomas R. Beal, Newbury, MA (US); Richard Edgar, Chelmsford, MA (US); Joan Ervey, Farmington, MA (US); Andrius Keturakis, New Castle, MA (US); Christine Robblee, Portsmouth, NH (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Wastech International, Inc., Portsmouth, NH (US)

(21) Appl. No.: 11/144,635

(22) Filed: Jun. 6, 2005

Related U.S. Application Data
(60) Provisional application No. 60/614,482, filed on Oct. 1, 2004.
(60) Provisional application No. 60/576,875, filed on Jun. 4, 2004.

(51) Int. Cl. C02F 9/14; C02F 9/02; C02F 9/12

(52) U.S. Cl. 210/605; 210/748; 210/205; 210/206; 210/241

(57) ABSTRACT

A modular, fully integrated, automatically controlled and transportable wastewater treatment system, including a support member, a bioreactor located on the support member, an aeration device, a membrane filter, an anoxic tank located on the support member, a disinfection unit located on the support member, and at least one pump located on the support member. Another embodiment includes a method and means of treating wastewater in a portable, integrated system supported by a support member, including deploying the support member to within proximity of a wastewater generation source, treating and nitrifying wastewater in a first tank on the support member, denitrifying wastewater in a second tank on the support member separating the wastewater into an effluent and a sludge via a membrane on the support member, disinfecting a portion of the effluent with a disinfection unit on the support member; and removing a portion of the sludge from the first tank, wherein all the steps are performed by a single integrate system configured to be transportable from one location to another.

### CROSS-REFERENCE TO RELATED APPLICATIONS

This application is related to, and claims priority to, co-pending application Ser. No. 60/576,875 filed Jun. 4, 2004, and co-pending application Ser. No. 60/614,482 filed Oct. 1, 2004. The contents of those applications are incorporated herein by reference.

### FIELD OF THE INVENTION

The invention relates to wastewater treatment systems such as systems that can treat a human wastewater stream produced in a domestic setting.

### BACKGROUND OF THE INVENTION

Residential or domestic wastewater generally includes wastewater from sinks, baths, washing machines, and toilets. In many residential settings, this wastewater is sent via public sewers to a treatment plant. At the treatment plant, the wastewater is typically treated with an aerobic technology in which active bacteria consume organic waste. In installations where a membrane bioreactor is used (a small footprint, highly effective form of aerobic technology), substantially clean wastewater passes through a membrane rendering it suitable for discharge. On the upstream side of the membrane, a portion of the wastewater (the solids component) must be removed (for example 1.5%) so that the system does not become clogged and new bacteria are allowed to propagate and continue to consume the waste. The outputs of such a system are thus clean wastewater removed on the downstream side of the membrane and solids (sludge) removed from the bioreactor on the upstream side of the membrane.

Such large-scale, centralized, public treatment systems are not suitable for all applications. For example, in certain residential settings, sewer access is not available because the residential location is remote from the sewering infrastructure, the residential setting does not lend itself readily to sewage systems (for example in low-lying areas), or the domestic or residential setting might only be temporary, for example, in the case of military or refugee camps.

### SUMMARY OF THE INVENTION

An exemplary embodiment of the invention provides a treatment system that can be used for treating domestic wastewater (sewage and/or gray water) at a location near the source of such wastewater. The exemplary embodiment provides, as outputs, clean wastewater and a small amount of secondary sludge that may optionally be converted into dried solids. The clean water may be treated to levels that meet strict environmental discharge requirements such that the water can be reused in certain applications. The secondary sludge can be used in agriculture or disposed of safely, and can be reduced approximately 50% in volume through the optional use of an integral sludge concentrator. An optional integral dryer may produce dried solids that are substantially inert and have a relatively small volume (typically an 80% volume reduction) so that they can easily be disposed of.

One exemplary embodiment of the invention provides a fully integrated and automatically controlled treatment train that effectively manages the task of converting domestic wastewater into environmentally benign and valuable products. One non-limiting embodiment is also advantageous in that, owing to its use of technology components, integrated operating design, and modular format, it is sufficiently small that it can be easily transported and deployed as a unit or plural small units. By way of example, a complete system can be provided in a housing or container that can be carried on a truck and set in place as a unit to service temporary base camps, refugees or disaster victims. For an example of one type of shipping container used, an 8′×8′6″×20′ (or 40′) metal cargo container may be used such as those found on ocean-going freightliners.

One non-limiting embodiment of the present invention includes a modular, fully integrated, automatically controlled and transportable wastewater treatment system, with a support member, a bioreactor located on the support member and including an aeration device and a membrane filter, an anoxic tank located on the support member, a disinfection unit located on the support member, and at least one pump located on the support member.

Another non-limiting embodiment of the present invention includes treating wastewater in a portable, integrated system supported by a support member, including the steps of deploying the support member to within proximity of a wastewater generation source, treating and nitrifying wastewater in a first tank on the support member, denitrifying wastewater in a second tank on the support member, separating the wastewater into an effluent and a sludge via a membrane on the support member, disinfecting a portion of the effluent with a disinfection unit on the support member; and removing a portion of the sludge from the first tank.

Another non-limiting embodiment of the present invention includes a modular, fully integrated, automatically controlled and transportable wastewater treatment system, including a bioreactor including an aeration device and a membrane filter, an anoxic tank, a disinfection unit, at least one pump, and means for supporting the bioreactor, anoxic tank, disinfection unit, and at least one pump as an integral and transportable unit.

The invention will be further appreciated from the detailed description of examples herein. It is to be understood, however, that in practicing the invention, a given embodiment need not have each and every feature of an example or examples disclosed herein and/or might not achieve all of the potential advantages of the preferred example or examples described herein. For example, in practicing the invention, one might choose to utilize certain features of the preferred embodiments disclosed herein, but not others, and thus, an embodiment following the teachings of the present invention could be constructed by utilizing a subset or subsets of one or more of the preferred examples disclosed herein.

### BRIEF DESCRIPTION OF THE DRAWINGS

FIG. 1 is a plan view of an example of one embodiment of the invention;

FIG. 2 is a perspective view of an alternate embodiment of the invention;

FIG. 3 shows a process and instrumentation diagram of one embodiment of the mobile wastewater treatment system;

FIG. 4 shows a perspective view of one embodiment of a mobile wastewater treatment system;

FIG. 5 shows a perspective view of another embodiment of the mobile wastewater treatment system;

FIG. 6 shows an example of another embodiment of a mobile wastewater treatment system;

FIG. 7 shows a perspective view of another embodiment of the mobile wastewater treatment system;

FIG. 8 shows a top view of one embodiment of a mobile wastewater treatment system;

FIG. 9 shows a system flow diagram for the wastewater treatment system;

FIG. 10 shows a system flow diagram for a modified wastewater treatment system;

FIG. 11 shows a perspective view of a typical support member/container arranged for shipment of the wastewater treatment system;

FIG. 12 shows a perspective view of the support member/container in open form as is typical during wastewater treatment system operation;

FIG. 13 shows a top view of one embodiment of the wastewater treatment system;

FIG. 14 shows a top view of another embodiment of the wastewater treatment system.

### DETAILED DESCRIPTION OF THE PREFERRED EMBODIMENTS

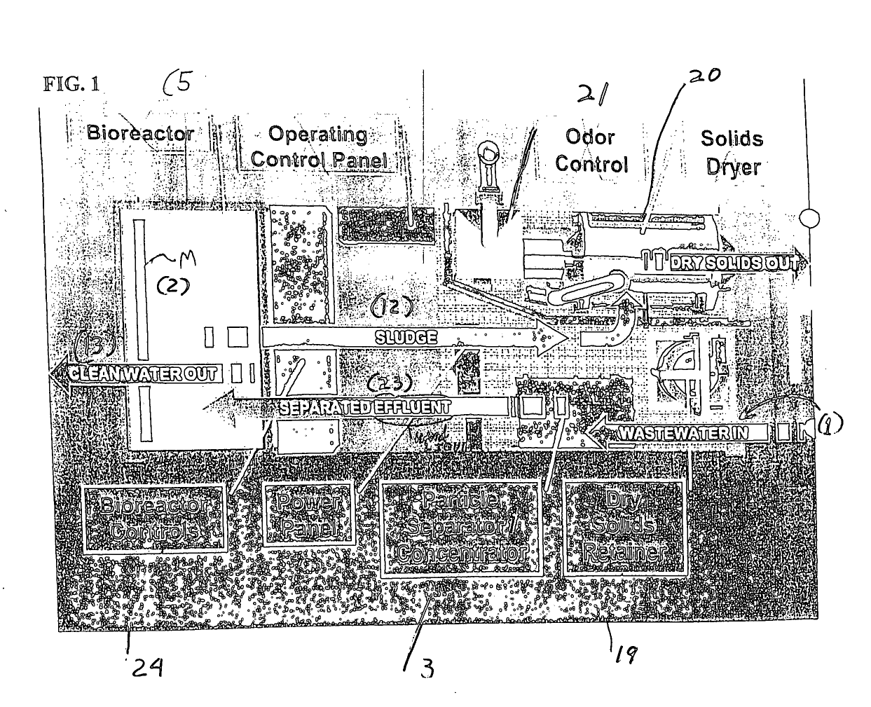

As shown in FIG. 1, in accordance with one example of the invention, the wastewater, for example, domestic wastewater, is initially input in the wastewater treatment system as shown by the arrow 1 “wastewater in.” Optionally, upstream of the “wastewater in,” a surge tank (not shown) can be provided to accommodate variations in the incoming domestic flow. The wastewater entering the system will initially encounter an optional particle separator 3. In another non-limiting embodiment, a separate particle separator 3 is disposed outside of the wastewater treatment system to remove particles from the wastewater prior to the introduction of the wastewater into the treatment system. Typically, particles of a size of 1/8 inch diameter or larger are removed with the particle separator 3. Where a particle separator 3 is provided at the location shown in FIG. 1, the particle separator 3 removes solids that, while often found in domestic wastewater, are not supposed to be associated with the wastewater itself. For example, cigarette butts, children's toys, etc may be removed by the particle separator 3. If an initial particle separator 3 is provided at the system inlet, the solids exiting from the separator may then be “wasted out” (i.e., removed from the system for disposal), or they could be provided to the solids dryer 20 as discussed hereinafter. The separated liquid 23 is then forwarded to the bioreactor 5 as shown in FIG. 1.

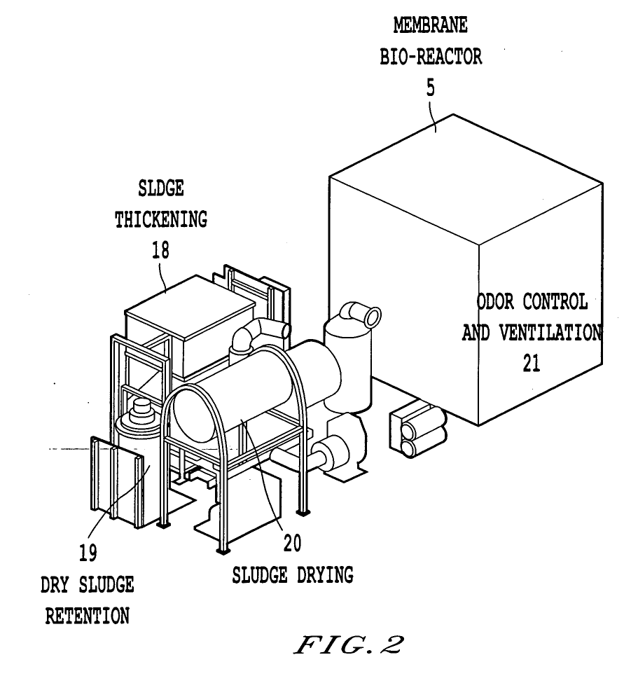

A sludge concentrator 18 (shown in FIG. 2) can be provided along the arrow 12 designated “sludge” so that the sludge is concentrated before entering the solids dryer 20 as discussed further hereinafter. In one embodiment, a separate concentrator concentrates the sludge flowing from the membrane bioreactor (discussed in detail below) prior to discharge of the sludge into a storage tank or (as an option), prior to drying.

Suitable controls are represented at the bioreactor controls portion 24, with an operating control panel also provided for operating the various components of the system. The controls can control the turning on and off of the various components and the flow between/among the various components. The bioreactor 5 may be of a known design, however, in one non-limiting embodiment, it has been custom made to be sized for a system suitable for domestic use at a location near to the location at which the wastewater is generated. For example, a bioreactor may be sized to receive approximately 7 gallons of wastewater per minute, or 10,000 gallons per day. This size of bioreactor 5 may readily satisfy typical requirements for twenty to forty residential homes. Additionally, the bioreactor is small enough to transport to a location where waste is generated. Therefore, problems such as the unavailability of municipal sewer connections can be solved. Typical methods of transporting the system include via rail and via tractor-trailers.

The bioreactor includes active bacteria in order to consume/treat the waste, with air being bubbled through the wastewater to provide a source of oxygen for the bacteria and also to provide mixing of the wastewater within the bioreactor. The mixing of the incoming waste is typically substantially instantaneous. The combination of wastewater and bacteria in the bioreactor is called “mixed liquor suspended solids” (MLSS) 7. As indicated at M in FIG. 1, a membrane 2 is provided such that clean water is extracted from the MLSS 7, with the membrane 2 serving as a barrier to retain all solids within the bioreaction chamber. The “clean water out” arrow 13 is a schematic representation in FIG. 1. By way of example, the membrane openings may have an effective size of approximately 0.1-0.4 μm. However, other sizes of membrane openings may be used. With this arrangement, the wastewater that has entered the bioreactor 5 must thus pass through the wall of the membrane 2 in order to enter the interior of the membrane unit, and the clean wastewater is then removed from the interior of the unit along the direction of the arrow 13, e.g., by a conduit in fluid communication with the interior of the membrane 2. Such bioreactor membranes 2 may be conventionally available. For example, Mitsubishi, Kubota and Zenon all manufacture membranes suitable for use in bioreactors. Alternatively, the membranes may be custom made to facilitate transport of the system. This would include membrane cassette units that have been configured to operate within the low overheight constraints of a transportable module.

Upstream of the membrane 2, the bacteria consume organic waste material. A portion of the MLSS 7 on the upstream side of the membrane 2 in the bioreactor must be removed in order to maintain the health of the bacterial population. Approximately 1.5% of the material on the upstream side of the membrane in the bioreactor is typically removed each day. For example, in a system that handles 10,000 gallons per day, 150 gallons of “secondary” sludge should be removed from the bioreactor per day. This volume of secondary sludge, as shown by the arrow 12 indicating “sludge,” can be cumbersome in a residential, military, refugee, or other similar settings. However, in accordance with one of the advantageous aspects of the invention, this sludge may be further treated through optional secondary sludge concentration and/or drying so that the disposal requirements are dramatically reduced. As indicated earlier, a sludge concentrator device 18 may be provided at the location along the “sludge” arrow 12 (between the location at which the material is removed from the bioreactor and the location at which the sludge enters the solids dryer 20). This sludge concentrator 18 can reduce the load and the power requirements of the solids dryer 20. For example, by doubling the concentration (reducing the volume) of solids in the material entering the solids dryer 20, the power requirements of the solids dryer 20 can be dramatically reduced. Liquid exiting the sludge concentrator 18 can then be returned to the bioreactor 5.

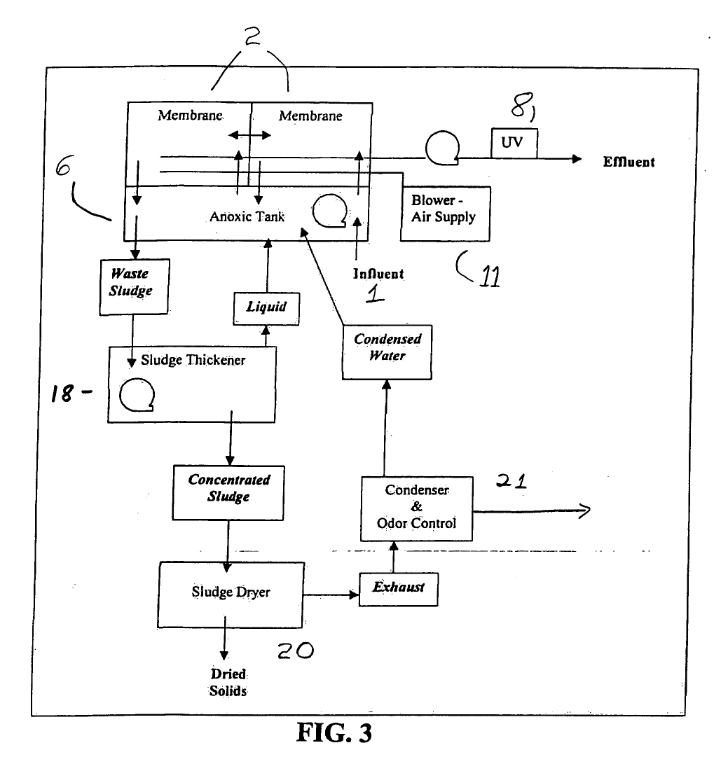

The sludge may then be stored in its concentrated form or sent to the optional solids dryer 20. The solids dryer 20 can include, for example, a rotating plow or blades that continuously “slosh” or move the waste against the heated walls of the interior of the dryer. The walls may be heated, for example, by a thermal fluid such as steam, and after a sufficient period of drying time, a granular or powder-like material results which is primarily dried, dead bacteria. By way of example, 150 gallons of sludge could be dried in such a drying apparatus in approximately twenty hours, which is sufficient for a system that can handle 10,000 gallons of wastewater per day. Solids can then be fed or dropped into a dry solids retainer 19 as shown in FIG. 3. Feed of solids to a dry solids retainer 19 can be by a trap door, an auger feed, or other suitable expedients. Forming one embodiment of the invention, an auger is preferably provided at the lower portion of the solids dryer 20 to breakup large dried flakes or clumps of material that may have accumulated in the bottom of the solids dryer 20, to allow the dried solids to be readily removed.

Exhaust from the solids dryer 20 will exit through an exhaust system which is optionally provided with an odor control unit as shown in FIG. 3. By way of example, the exhaust (which is typically primarily steam) can pass through a carbon bed so as to eliminate odors prior to exiting through the exhaust system. It is to be understood, however, that the use of the solids dryer 20 is optional, and that even when the solids dryer 20 is used, refeed of the steam to the odor control unit is optional.

FIG. 2 illustrates a perspective view of a modified embodiment of the invention. In the arrangement of FIG. 2, a sludge concentrator 18 is provided to receive sludge from the bioreactor 5 and to thicken the sludge before entering the solids dryer 20. The clean water exiting the system is typically treated sufficiently to meet or exceed environmental requirements for “secondary effluent treatment” including less than 30 mg/L total suspended solids and less than 30 mg/L BOD₅. In fact, one embodiment of the system routinely achieves a BOD₅ of less than 5 mg/L, with total suspended solids also less than 5 mg/L. The system optionally includes a disinfection device located on the treated water exit line that typically reduces pathogenic bacteria and viruses to levels that are safe for human body contact. The disinfection means selected in one non-limiting embodiment is ultraviolet radiation (UV). It is to be understood that other means of disinfection, such as chlorination, can also be used.

The system is suitable for various commercial, residential, and government/military applications. While the system presented is intended primarily for land-based use, the system could also be used in other environments, for example, on Naval vessels. Although the treatment system is shown in a portable housing, it is to be understood that the treatment system can be installed in a building on a permanent or semi-permanent basis, or can be installed on a portable component, such as a pallet.

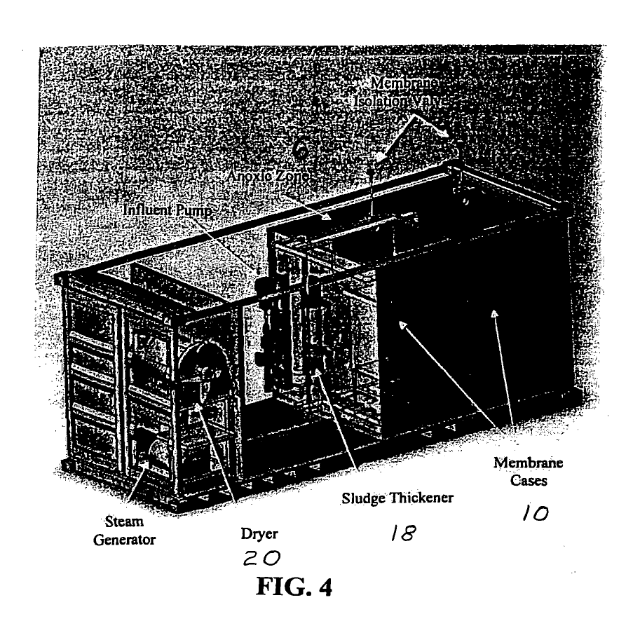

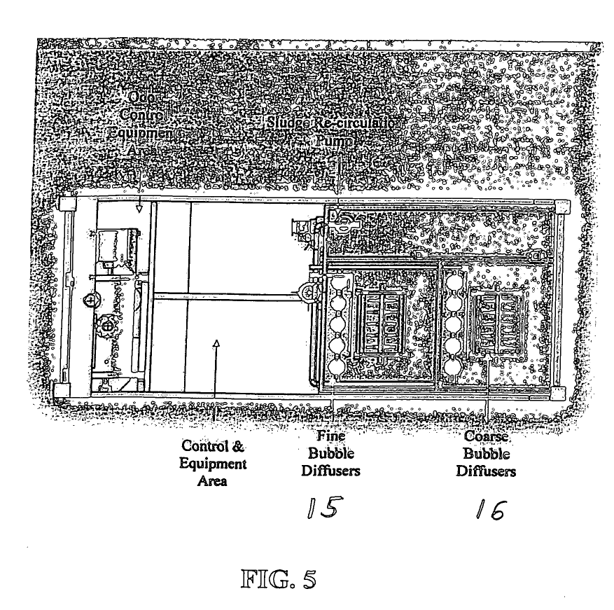

FIGS. 3-5 show an example of a mobile wastewater treatment system, which can treat up to 10,000 gallons per day of municipal strength wastewater. As shown in FIG. 4, the system may be configured to be supported on a single, integrated frame 14. In one non-limiting embodiment, the system can reduce an amount of total suspended solids (TSS), five-day biochemical oxygen demand (BOD₅), and/or coliforms in an effluent to levels permitting safe sub-surface land discharge in the most environmentally sensitive areas (e.g., BOD₅ and TSS at <5 mg/L, CFU <200).

In one non-limiting embodiment, the treatment system can break down organics and/or ammonia in the wastewater to produce a clean final effluent. The use of membranes 2 in the biological process may effectively remove most or all bacteria from the effluent prior to ultra-violet (UV) disinfection. The UV source 8 can reduce or effectively eliminate pathogenic organisms such as bacteria and viruses, which may otherwise be present in the effluent. It is to be understood, however, that depending on the use or location of the exit of water from the treatment system, UV disinfection may not be required. Nitrification and de-nitrification of the wastewater may be performed to reduce the ammonia and nitrates to environmentally safe levels. The treatment system can further capture the sludge by-product produced by the bioreactor 5, concentrate the solids, and dry the waste into an inert granular form. In one non-limiting embodiment of the invention, the dry waste has less than 50 percent moisture content. An optional odor control unit (OCU) 21 may be used to minimize the odors produced from the drying process.

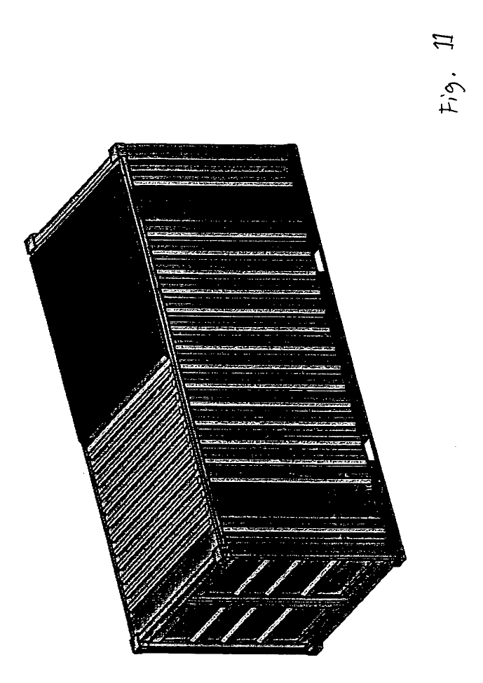

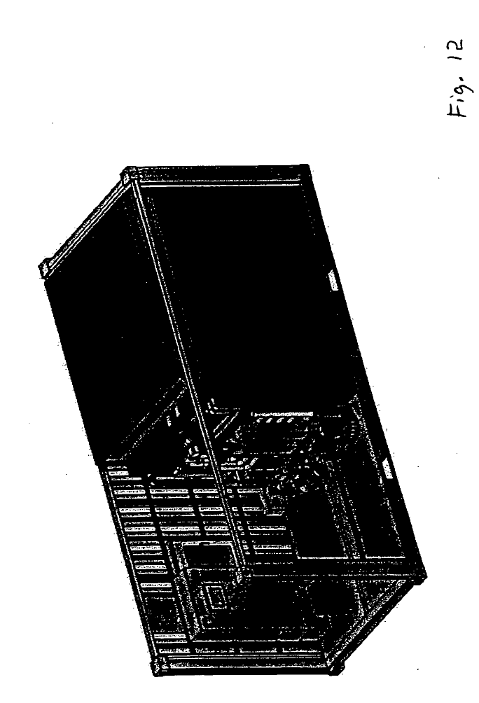

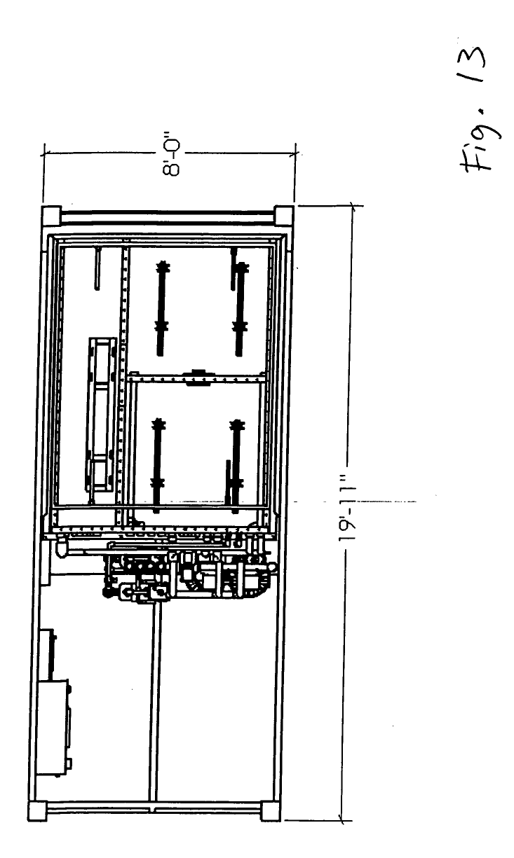

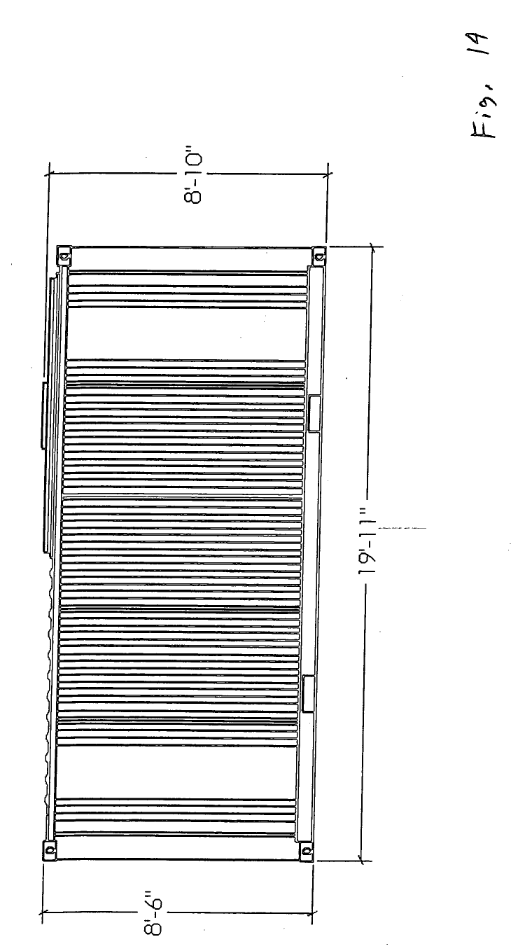

In FIGS. 11-14, one embodiment of the system is shown illustrating the close-coupling of three key treatment system steps in a physical configuration that can be easily integrated into a housing that is suitable for air, sea and land transport (e.g., container/support member 26). For example, container/support member 26 is typically configured to be transported overseas via freight-liner. Additionally, the container/support member 26 may typically travel over land via train or tractor-trailer.

Table 1 shows typical municipal wastewater characteristics that can be treated by the treatment system. The table also discloses expected effluent concentrations after treatment of the wastewater by the treatment system.

| | | Wastewater | |
|---|---|---|---|
| Parameter | Unit | Influent | Effluent |
| BOD₅ | mg/L | 250 | <5 |
| TSS | mg/L | 250 | <5 |
| TKN—Total Kjeldahl | mg/L | 35 | 1 |
| Nitrogen (organically | | | |
| bound nitrogen and ammonia) | | | |
| T-N—Total nitrogen | mg/L | 35 | <10 |
| NH₃—Ammonia | mg/L | 35 | 1 |

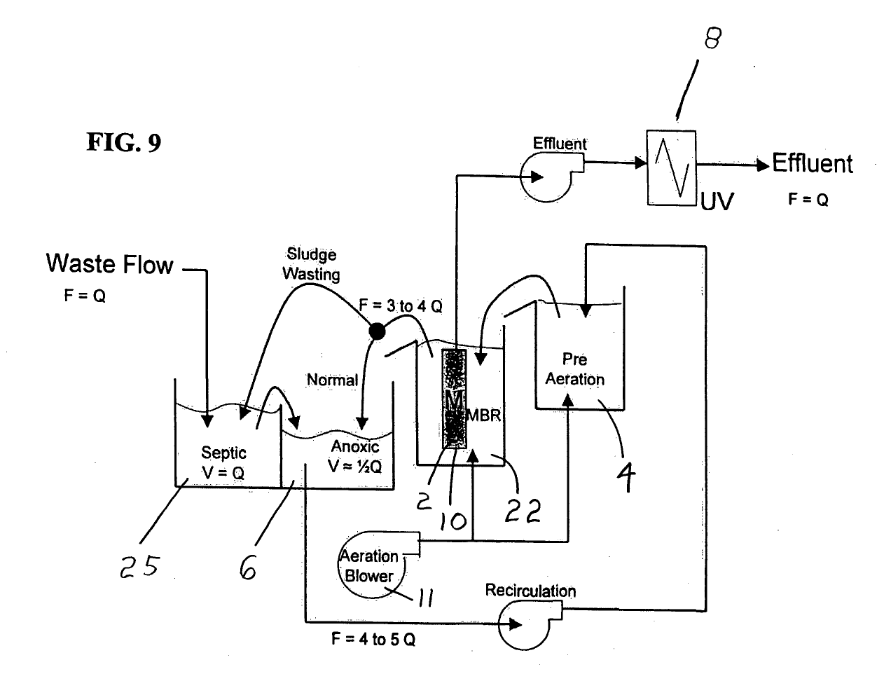

The treatment system can be used with one or more components, such as an equalization tank 25 (FIG. 9) to regulate the wastewater flow, or a component (particle separator 3) for pre-screening the influent to remove particles prior to entry of the influent to the treatment system to protect the membranes 2 from damage. The treatment system can be controlled to pump the influent wastewater at a rate less than or equal to the processing rate of the bioreactor 5. Typical applications may include the treatment of wastewater at a rate of about 7 GPM. One or more membrane bioreactor (MBR) tank(s) 22 may contain a mixture of wastewater and bacteria (MLSS 7), which circulates from the anoxic tank 6 to membrane tank(s) 22, and then back to the anoxic tank 6. The membrane tank(s) 22 are supplied with air via a blower 11 to create an aerobic environment for nitrifying bacteria to thrive and to continuously clean the membrane surfaces. Aerobic digestion of the wastewater organics and nitrification of ammonia occurs in the aerated membrane tanks. The nitrifying bacteria convert the wastewater ammonia to nitrate, which is de-nitrified when it is recycled into the anoxic tank 6. The membrane tank(s) 22 will include membrane cartridges (flat plate or tubular), which filter the MLSS 7 to produce clean effluent. Coarse bubbles are supplied in the tank to clear the membrane surfaces of excess sludge build up while fine air bubbles provide oxygen to the bacteria. As the bacterial colony growth continues, excess sludge may be removed from the MBR 5 to optimize conditions for biological activity. Periodic removal of some sludge also maintains an appropriate transmembrane pressure across the membrane surfaces. An optional sludge concentrator 18 may be used to concentrate waste sludge, which is periodically removed from the MBR 5 prior to drying. In a typical application, about 1.5% of the daily influent flow rate is removed. Thus, in one embodiment, the treatment system can remove about 150 gallons of waste sludge per day. The sludge concentrator 18 typically removes approximately 50 to 60 percent of excess liquid from the sludge. Polymer added to the sludge causes the solid particles to flocculate together. After a waiting period, the liquid portion is drawn off the bottom first and is sent back to the MBR 5. The sludge portion (now reduced in volume) is removed and sent to sludge disposal, or to the solids dryer 20 if this option is included. Most of the polymer typically stays entrained in the solids, leaving very little residual in the liquid portion.

The optional solids dryer 20 can heat the sludge until a predetermined amount of water is evaporated off (such as by the use of steam). The concentrated (reduced volume) sludge may be dried into a granular form, which typically contains <50 percent moisture content. Agitation applied during the drying process brings the sludge into contact with the surfaces of the interior of the solids dryer 20, which may be heated. The solids dryer 20 then conditions the sludge. For example, the sludge may be made into small granules.

The optional odor control unit 20 may be used to treat exhaust created by the solids dryer 20. Condensing the steam from the exhaust pipe exiting the solids dryer 20 treats odors created during the solids drying process. The water produced by condensing the steam may be recycled back to the MBR 5 for further treatment. Additionally, an activated carbon bed may be used to absorb odors from the exhaust air.

In one non-limiting embodiment, the treatment system includes three partitions in one tank. Two aerated partitions hold the membranes and air diffusers. The third partition is the (un-aerated) anoxic tank 6. The MLSS 7 typically cycles continuously through these partitions while the clean effluent is pulled through the membranes 2 and sent to the optional ultraviolet disinfection unit, UV source 8, prior to discharge. Multiple membrane tanks 22 can be used in parallel. In one embodiment of the invention, when multiple membrane tanks are used, valves 9, either manual or automatic, allow for either membrane tank section to be isolated for system maintenance. When one tank is isolated, the flow rate through the operating membrane tanks can be significantly increased for short periods of time. This can minimize the impact of MBR maintenance on the process capability of the system.

Tank sizes and flow rates can be determined to provide the average retention times needed for the wastewater treatment based on the usage of the system. In one non-limiting embodiment, the treatment system has an average retention time of about 4.8 hours in the aerated sections of the MBR 5. The residence time is determined based on the tank volume, the daily system design flow, the wastewater's organic strength, bioreactor sludge concentration, and/or amount of air supplied to the tank. Tank sizing is calculated using the food to microorganism ratio (F:M) to determine the amount of residence time needed for the bacteria to digest the organics and for the ammonia to nitrate conversion (nitrification). In the F:M ratio, the food represents the organic strength of the wastewater (lbs BOD₅/day) and M, the microorganism value, is the concentration of the sludge bacteria (lbs TSS/gallon), which digest the food.

In one exemplary embodiment, the un-aerated anoxic tank volume provides an average retention time of about 2 hours. The anticipated nitrogen load and recycle rate of the wastewater with the aerated tanks may be used to determine the time for the de-nitrifying bacteria to convert the nitrate compounds to nitrogen gas and carbon dioxide. With both aerated and un-aerated tank volumes combined, the total hydraulic retention time (HRT) is typically about 6.6 hours. This is sufficient time to treat the wastewater organics and nitrogen to meet the effluent levels listed in table 1.

Other exemplary embodiments of components of the treatment system are now described.

MBR

To treat the influent wastewater to the desired effluent quality limits, the system typically includes one or more membrane cassettes 10. The membrane cassettes 10 usually hold one or more individual membrane cartridges, which can be easily cleaned or replaced as needed.

Pre-aeration is a process used to increase the level of dissolved oxygen in the MLSS 7 and make it available to the bacteria. This can be accomplished either in a separate pre-aeration tank or in the membrane tank 22.

An anoxic tank 6 is typically used to remove nitrogen (in the form of nitrate) from the wastewater and to control the wastewater pH level. If the level of nitrate or total nitrogen in the effluent does not have to be controlled, then this tank may be eliminated and pH control, if necessary, can be accomplished by adding small doses of chemicals if necessary.

In one non-limiting embodiment, the biological process may be contained entirely in the structure/container/pallet. Additionally, the anoxic tank 6 on the structure/container/pallet may be optionally converted to an aerobic chamber and the function of anoxic tank 6 moved to an external location in order to increase overall wastewater processing capability.

The blower 11 supplies a predetermined amount of air to membrane tanks 22 through diffuser manifolds 15 and/or 16. The diffusers 15 are configured to provide fine bubbles. The diffusers 16 are configured to provide coarse bubbles. In other words, the bubbles produced by diffuser 16 are larger than the bubbles produced by diffuser 15. The diffusers 15 and 16 may also contain a clean in place (CIP) system (not shown) for easy maintenance. In some applications, an eductor can be used to replace or supplement the fine bubble diffuser. Pumps 17 are used to circulate the sludge flow though the bioreactor tanks 22 and to permeate the effluent from the membranes 2. The pumps 17 are typically selected to accommodate the flow rates and material handling rates based on the use of the system.

Sludge Concentrator

In one non-limiting embodiment, the sludge concentrator 18 contains a chamber for liquid/solids separation, a vacuum pump to evacuate the air from the chamber, and a polymer mixing/dosing mechanism (not shown). In one non-limiting embodiment, the chamber is cylindrical, for example. However, other shapes or concentration methods may be used.

The polymer mixing equipment makes a diluted solution of polymer from dry granules and water. The polymer solution is dosed into the sludge stream as it is pumped to a separation chamber.

The vacuum pump removes air from above the sludge and helps entrained air bubbles in the sludge float out of the concentrated sludge to the top of the tank. The liquid portion is typically sent back to the MBR 5 for treatment, and the concentrated sludge moves on for disposal or to a holding tank for the solids dryer 20. Alternatively, the concentrated sludge may flow directly into the solids dryer 20.

Sludge Dryer

In one non-limiting embodiment the sludge dryer 20 is a steam jacketed cylindrical drum with rotating paddles inside. The paddles agitate the sludge during the drying process. However, other shapes, agitation methods and heat sources may be used. In one non-limiting embodiment, an exit valve for the sludge contains an auger device, which aids in dry solids removal from the dryer. After drying, the solids may flow into an optional containment drum 19 for disposal. An optional scale under the drum may be used to determine the weight and to determine a routine removal schedule for the system.

Odor Control Unit

The odor control unit 21 may include a condenser and/or carbon unit, which capture any steam and associated sludge odors in the exhaust created by the solids dryer 20.

System Control

The system may be controlled by a control unit such as a programmable logic controller (PLC), for example. A set of sensors, including flow meters, pressure sensors, level switches, temperature, pH, and dissolved oxygen may constantly monitor all aspects of the process. In addition, sensors integral with motors and the UV source 8 may monitor the function of these units. Typically all of meters and sensors may provide input to the PLC. Based on this input and a complex control scheme, the PLC typically determines when particular pumps, blowers, valves, UV, etc. should be in operation to process the wastewater.

Additionally, the system may incorporate a small LCD display for alarms and alerts. When the PLC detects a problem with the system, an alert (for minor problems) or an alarm (for more serious problems) may be displayed to an operator. For example, the PLC may be used to display the alert or alarms. The control display may also include modifiable operator set points for the system in case changes in operation parameters are needed.

Treatment System Packaging Options

In one exemplary embodiment, the system can be configured as a mobile wastewater treatment system that may be containerized in a form conducive to transport and which can be placed in an area where space is limited. All necessary equipment can be located inside of the container (for example, a standardized shipping container). Another option for the system is to palletize the equipment for placement in a building rather than a mobile container, or to install the treatment system in a building or structure. These embodiments still provide the advantages of a system located near the source of wastewater generation compared to systems located at a centralized wastewater treatment plant.

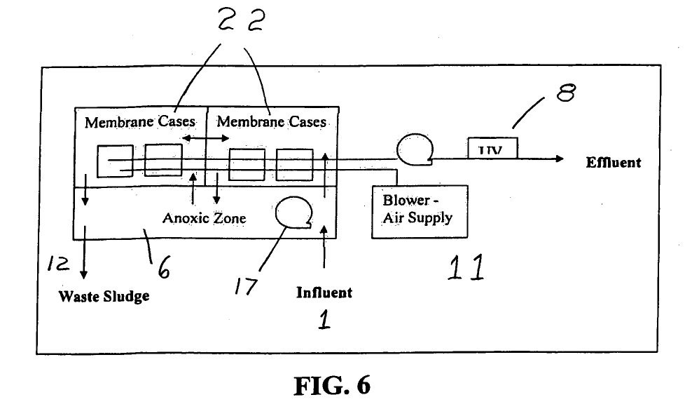

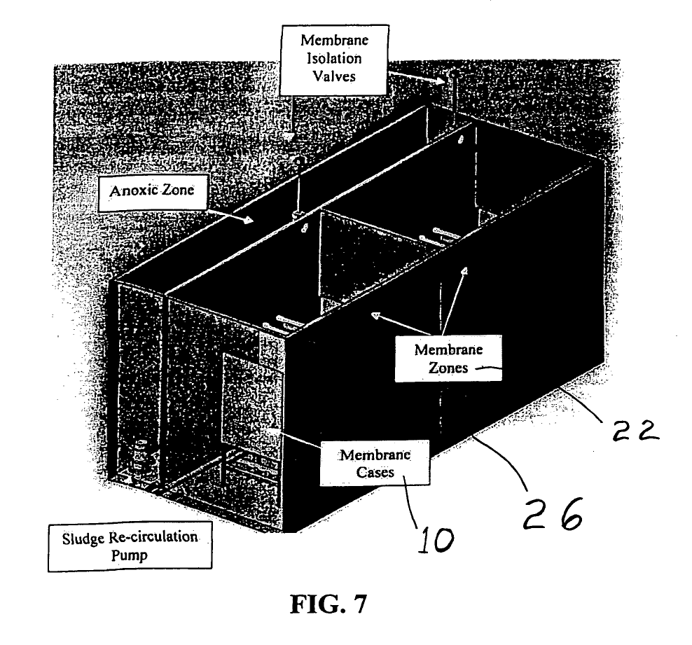

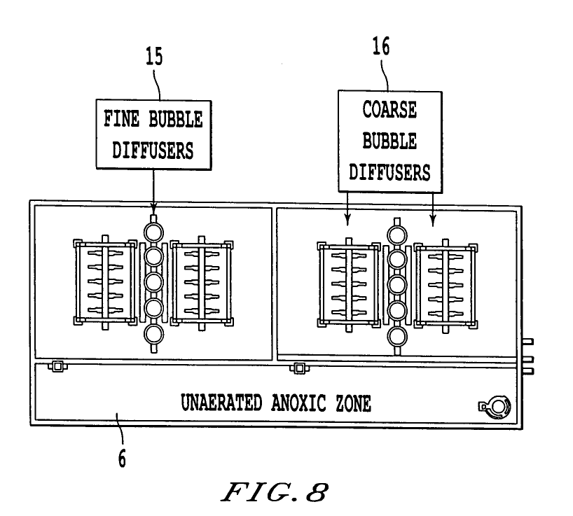

FIGS. 6-8 show an example of one embodiment of a mobile wastewater treatment system. This non-limiting embodiment can treat up to 20,000 gallons per day of municipal strength wastewater. It is to be understood that more than 20,000 gallons per day of municipal wastewater can be treated by connecting one or more of the treatment systems in parallel to one another. In one non-limiting embodiment, the system can reduce an amount of total suspended solids (TSS), five-day biochemical oxygen demand (BOD₅), and/or coliforms in an effluent to levels permitting safe sub-surface land discharge in the most environmentally sensitive areas (e.g., BOD₅ and TSS at <5 mg/L for effluent requirements). Although the embodiment shown in FIGS. 6-8 does not include a dryer or odor control unit, it is to be understood that these components can optionally be included.

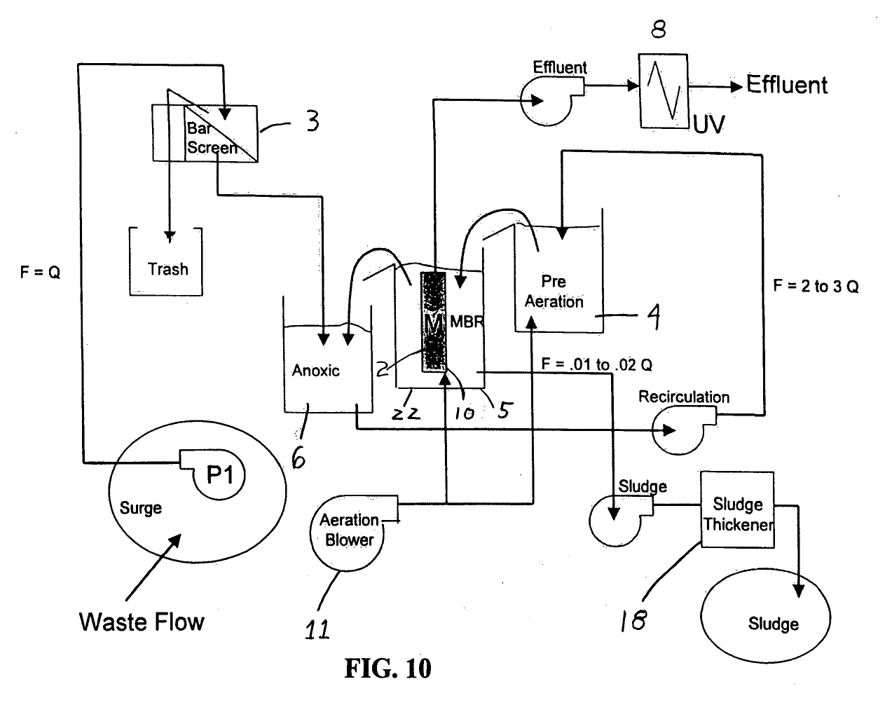

FIGS. 9-10 show typical flow schematics of two non-limiting embodiments of packaged wastewater plants. These can apply to any size plant from 2000 gallons per day to 50,000 gallons per day, depending on the concentration of the wastewater, on the treatment requirements for the effluent and on the components selected. Outside this range, the technology will apply, but other types of systems sometimes have cost advantages. However, embodiments of the present invention have an advantage if projected growth is expected in the amount of wastewater to be treated. For example, a customer may install a unit sized to treat 30,000 gpd and install an additional unit or units in the future in parallel with the first unit in order to handle increased demand.

Numerous modifications and variations of the present invention are possible in light of the above teachings. It is therefore to be understood that within the scope of the appended claims, the invention may be practiced otherwise than as specifically described herein.

1. A modular, fully integrated, automatically controlled and transportable wastewater treatment system, comprising:
a support member;
a bioreactor located on the support member and including an aeration device and a membrane filter;
an anoxic tank located on the support member;
a disinfection unit located on the support member; and
at least one pump located on the support member.

2. The wastewater treatment system of claim 1, further comprising a control unit located on the support member.

3. The wastewater treatment system of claim 1, further comprising:
inlet plumbing on the support member which allows wastewater to be added to the bioreactor;
outlet plumbing on the support member which allows effluent passed through the membrane filter of the bioreactor to leave the bioreactor; and
outlet plumbing on the support member which allows sludge separated from the effluent by the membrane filter to leave the bioreactor.

4. The wastewater treatment system of claim 1, wherein the support member is a standardized shipping container or other transportable housing.

5. The wastewater treatment system of claim 1, wherein the support member is a frame.

6. The wastewater treatment system of claim 5, wherein the frame is configured to fit on a tractor-trailer.

7. The wastewater treatment system of claim 1, wherein the disinfection unit is an ultraviolet light source.

8. The wastewater treatment system of claim 1, wherein the disinfection unit is downstream of the bioreactor and in fluid communication with a treated water outlet portion of the bioreactor.

9. The wastewater treatment system of claim 1, further comprising a sludge concentrator located on the support member.

10. The wastewater treatment system of claim 9, wherein the sludge concentrator includes a vacuum pump.

11. The wastewater treatment system of claim 9, wherein the sludge concentrator is located downstream of the bioreactor and in fluid communication with an MLSS recirculation portion of the bioreactor and sludge is periodically removed from the MLSS recirculation portion to the sludge concentrator.

12. The wastewater treatment system of claim 9, wherein the sludge concentrator is configured to reduce a volume of the sludge by at least approximately 50%.

13. The wastewater treatment system of claim 1, further comprising an odor control system on the support member.

14. The wastewater treatment system of claim 13, wherein the odor control system includes a carbon filter.

15. The wastewater treatment system of claim 13, wherein the odor control system includes a vapor condenser.

16. The wastewater treatment system of claim 1 further comprising a solids dryer on the support member.

17. The wastewater treatment system of claim 16, wherein the solids dryer is downstream of the bioreactor and in fluid communication with an MLSS recirculation portion of the bioreactor and sludge is periodically removed from the MLSS recirculation portion to the solids dryer.

18. The wastewater treatment system of claim 16, wherein the solids dryer is downstream of the bioreactor and in fluid communication with an outlet of a sludge concentrator and sludge is periodically removed from the sludge concentrator to the solids dryer.

19. The wastewater treatment system of claim 16, wherein the solids dryer is heated with steam.

20. The wastewater treatment system of claim 16, wherein the solids dryer is configured to dry solids to a moisture content of no more than approximately 50%.

21. The wastewater treatment system of claim 1, wherein the wastewater treatment system is configured to be in parallel fluid communication with a second wastewater treatment system.

22. A method of treating wastewater in a portable, integrated system supported by a support member, comprising:
deploying the support member to within proximity of a wastewater generation source;
treating and nitrifying wastewater in a first tank on the support member;
denitrifying wastewater in a second tank on the support member;
separating the wastewater into a treated effluent and a sludge via a membrane on the support member;
disinfecting a portion of the effluent with a disinfection unit on the support member; and
removing a portion of the sludge from the first tank.

23. The method according to claim 22, further comprising controlling the wastewater treatment system with a controlling unit on the support member.

24. The method according to claim 22, further comprising reducing a first volume of the sludge to a second volume with a first reducing device on the support member.

25. The method according to claim 24, wherein reducing the first volume of the sludge includes exposing the first volume of sludge to a pressure less than atmospheric pressure in the first reducing device.

26. The method according to claim 24, further comprising reducing the second volume of sludge in a second reducing device on the support member.

27. The method according to claim 26, wherein reducing the second volume of the sludge comprises heating the second reducing device with at least one of a thermal fluid and electrical resistance element.

28. The method according to claim 22, wherein disinfecting the effluent includes exposing the effluent to an ultraviolet light source.

29. A modular, fully integrated, automatically controlled and transportable wastewater treatment system, comprising:
a bioreactor including an aeration device and a membrane filter;
an anoxic tank;
a disinfection unit;
at least one pump; and
means for supporting the bioreactor, anoxic tank, disinfection unit, and at least one pump as an integral and transportable unit.

30. The wastewater treatment system of claim 29, further comprising a controlling unit located on the means for supporting the bioreactor, anoxic tank, disinfection unit, and at least one pump as an integral and transportable unit.
